(19) United States
(12) Patent Application Publication
(10) Pub. No.: US 2007/0256567 A1
(43) Pub. Date: Nov. 8, 2007

(54) Cup with added function

(75) Inventor: Liang Jhong-Cyuan, Taipei City (TW)

Correspondence Address: BIRCH STEWART KOLASCH & BIRCH, PO BOX 747, FALLS CHURCH, VA, 22040-0747, US

(73) Assignee: BIGTOM INTERNATIONAL LTD.

(21) Appl. No.: 11/416,207

(22) Filed: May 3, 2006

(51) Int. Cl. A23L 1/00

(52) U.S. Cl. 99/275

(57) ABSTRACT

A cup having a receptacle fixedly connected between the periphery of the cup body and the handle thereof, the receptacle having a horizontal rim outwardly extending from the topmost edge thereof and a tapered receiving open chamber cut through top and bottom sides thereof for holding a rod-like member, for example, a piece of egg roll.

### BACKGROUND OF THE INVENTION

1. Field of the Invention

The present invention relates to cups and more particularly, to a cup with added function, which has a receptacle on the outside of the cup body for holding a rod-like food (for example, a piece of egg roll), a wire hole for the hanging of the pull cord of a tea bag when making tea, and a thumb rest for the resting of the thumb of the hand holding the handle of the cup.

2. Description of the Related Art

A cup is a bowl-shaped drinking vessel usually with a handle. FIG. 7 illustrates a cup made according to Taiwan Patent Publication 401795. According to this design, the cup has a cap 60 and a handle 61. The handle 61 has one end fixedly connected to the cap 60, which is capped on the cup body 64, and the other end connected to a ring 62 that is sleeved onto the cup body 64. Further, the handle 61 has a through hole 63 at the top side for holding a straw 70. This structure of cup has drawbacks as follows:
1. When holding a straw in the through hole of the handle, the straw may fall from the through hole of the handle easily.
2. The handle of the cup is molded from plastics and not strong enough. When holding the handle with the hand, the cup body may vibrate.

FIG. 8 illustrates a cup made according to Taiwan Patent Publication M274882. According to this design, the cup 80 has the top open side sealed with a circular seal film 81. The circular seal film 81 has a protruding border area 82 extending out of the rim of the cup 80 and a hole 83 in the protruding border area 82 for holding a straw 70. According to this design, the straw 70 may fall easily from the hole 83 of the circular seal film 81.

FIG. 9 illustrates a cup made according to Taiwan Patent Publication M274882. According to this design, the cup 90 has a retaining notch 92 on the top rim 91 for the handing of the pull cord 94 of a tea bag 93 that is put in hot water in the cup 90. According to this design, the retaining notch 92 destructs the structural strength of the cup 90, therefore the cup 90 tends to break when squeezed. Further, this design of cup has no means to hold a straw.

### SUMMARY OF THE INVENTION

The present invention has been accomplished under the circumstances in view. According to one aspect of the present invention, the cup comprises a cup body, a handle, and a receptacle fixedly connected between the periphery of the cup body and the handle. The receptacle defines a tapered receiving open chamber for holding a rod-like food, for example, a piece of egg roll. According to another aspect of the present invention, the receptacle has a wire hole on a horizontally extending top rim thereof for the hanging of the pull cord of a tea bag when putting the tea bag in hot water in the cup body to make tea. The wire hole is comprised of a circular hole and a narrow guide slot extending from the circular hole to the border of the horizontally extending top rim of the receptacle. The narrow guide slot can be a straight slot or curved slot. According to still another aspect of the present invention, the handle has a thumb rest at the top side of the resting of the thumb of the hand holding the handle.

### BRIEF DESCRIPTION OF THE DRAWINGS

FIG. 1 is an elevational view of a cup in accordance with the present invention.

FIG. 2 shows an application example of the present invention.

FIG. 3 is a side view in section of FIG. 3.

FIG. 4 is a schematic perspective view showing another application example of the present invention.

FIG. 5 is an enlarged view of a part of FIG. 5 showing the pull cord of the tea bag hung in the wire hole at the horizontal rim of the receptacle.

FIG. 6 is a schematic drawing showing the user's thumb rested on the thumb rest at the top side of the handle of the cup according to the present invention.

FIG. 7 is a schematic drawing showing the use of a cup made according to Taiwan Patent Publication 401795.

FIG. 8 is a schematic drawing showing the use of a cup made according to Taiwan Patent Publication M274882.

FIG. 9 is a schematic drawing showing the use of a cup made according to Taiwan Patent Publication M274882.

### DETAILED DESCRIPTION OF THE PREFERRED EMBODIMENT

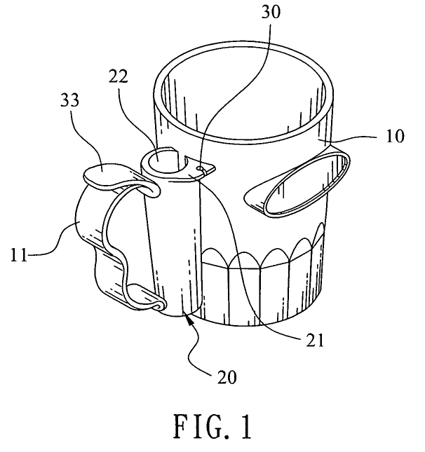

Referring to FIGS. 1 and 5, a cup in accordance with the present invention is shown comprising a cup body 10, a handle 11, and a receptacle 20 connected between the outside wall of the cup body 10 and the two distal ends of the handle 11. The receptacle 20 defines a tapered through hole 22. Further, the receptacle 20 has a horizontal rim 21 extending outward from the topmost edge and a wire hole 30 cut through the horizontal rim 31. The wire hole 30 is comprised of a circular hole 31 cut through the top and bottom sides of the horizontal rim 21, and a narrow guide slot 32 cut through the top and bottom side of the horizontal rim 21 and extending from the circular hole 31 to the border of the horizontal rim 21. The narrow guide slot 32 can be a straight slot, or a curved slot.

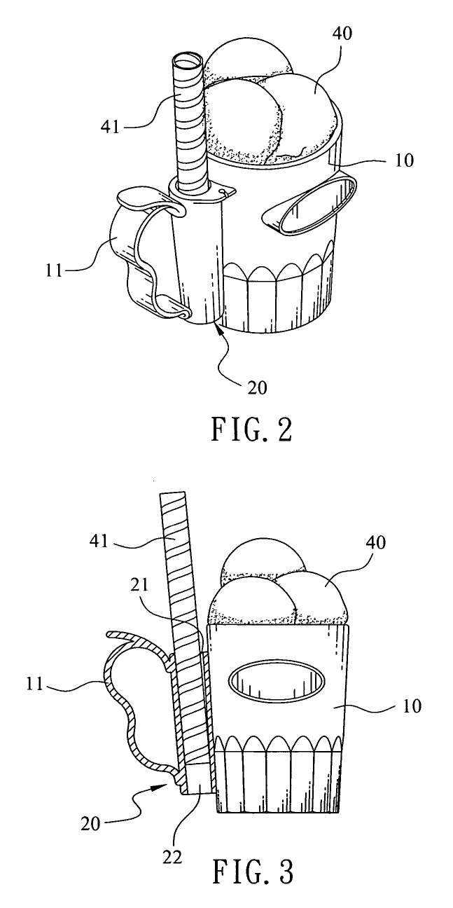

Referring to FIGS. 2 and 3, the cup body 10 can be used to hold ice cream 40, and the tapered through hole 22 of the receptacle 20 can be used to hold a piece of egg roll 41. Because the tapered through hole 22 has a diameter gradually reducing from the top side of the receptacle 20 to the bottom side of the receptacle 20 and because the tapered through hole 22 extends through the top and bottom sides of the receptacle 20, the egg roll 41 is stably secured to the receptacle 20 after its insertion, and egg roll chips are allowed to fall out of the receptacle 20. The receptacle 20 can also be used to hold a rod-like member such as a suction tube or stirring spoon.

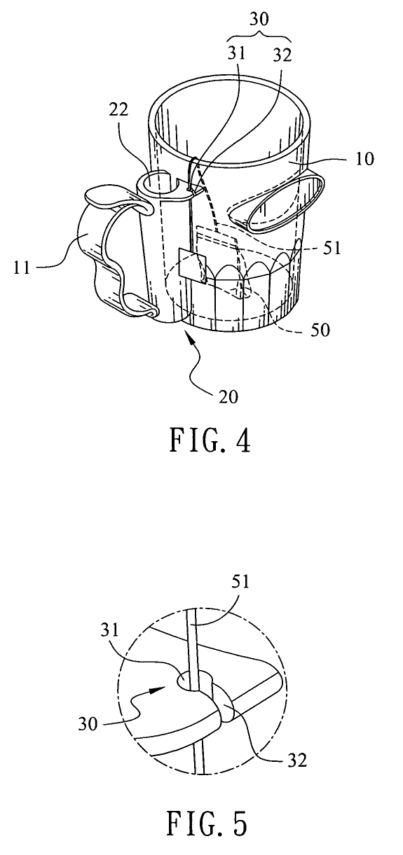

Referring to FIG. 4 and FIG. 5 again, when using the cup for preparation of tea, the tea bag 50 is put in hot water in the cup body 10, and the pull cord 51 of the tea bag 50 is put through the narrow guide slot 32 of the wire hole 30 into the circular hole 31. When stirring the tea water in the cup body, the pull cord 51 is kept suspending in the circular hole 31 and will not be moved out of the wire hole 30 easily.

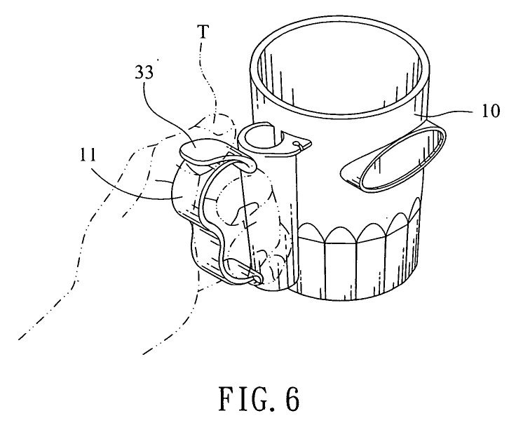

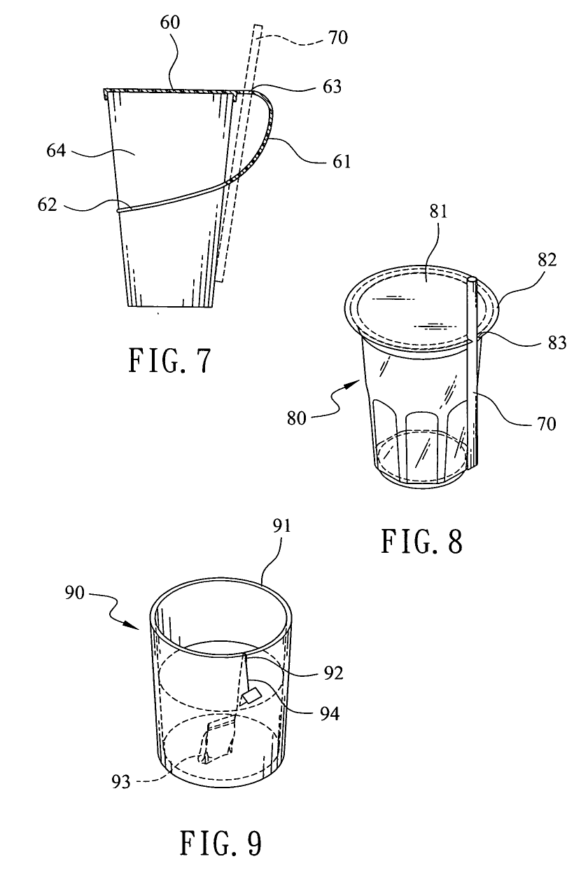

Referring to FIG. 6 and FIG. 1 again, the handle 11 of the cup has a thumb rest 33 at the top side for the resting of the thumb T of the hand holding the handle 11. Therefore, the user can hold the cup firmly with less effort.

As described above, the invention provides a cup with added function that has the benefits as follows:

1. The cup has a receptacle connected between the outside wall of the cup body and the handle for a piece of egg roll or any of a variety of rod-like members. Because the tapered receiving open chamber of the receptacle cuts through the top and bottom side of the receptacle, it is easy to wash the receptacle.

2. The wire hole at the horizontal rim of the receptacle is comprised of a circular hole cut through the top and bottom sides of the horizontal rim and a narrow guide slot cut through the top and bottom side of the horizontal rim and extending from the circular hole to the border of the horizontal rim, the user can hung the pull cord of the tea bag in the wire hole when putting the tea bag in hot water in the cup body 10 to make tea.

3. The handle has a thumb rest at the top side for the positioning of the thumb of the hand holding the handle, therefore the user can hold the cup firmly with the hand with less effort.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A cup comprising a cup body, a handle, and a receptacle fixedly connected between the periphery of said cup body and said handle, said receptacle having a tapered receiving open chamber cut through top and bottom sides thereof and a horizontal rim outwardly extending from the topmost edge thereof, said tapered receiving open chamber gradually reducing from the top side of said receptacle toward the bottom side of said receptacle.

2. The cup as claimed in claim 1, wherein said receptacle has a wire hole cut through top and bottom sides of said horizontal rim.

3. The cup as claimed in claim 2, wherein said wire hole is comprised of a circular hole and a narrow guide slot extending from said circular hole to the border of said horizontal rim.

4. The cup as claimed in claim 3, wherein said narrow guide slot is a straight slot.

5. The cup as claimed in claim 3, wherein said narrow guide slot is a curved slot.

6. The cup as claimed in claim 1, wherein said handle has a thumb rest at a top side thereof for the resting of the hand holding said handle.
